(19) United States
(12) Patent Application Publication
(10) Pub. No.: US 2018/0288171 A1
(43) Pub. Date: Oct. 4, 2018

(54) LOCATION-BASED CONTENT DELIVERY AND OPTIMIZATION

(71) Applicant: THOMSON Licensing, Issy-les-Moulineaux (FR)

(72) Inventors: Joel M. FOGELSON, Pasadena, CA (US); Samir Ahmed, Culver City, CA (US)

(21) Appl. No.: 15/764,853

(22) PCT Filed: Sep. 30, 2015
(86) PCT No.: PCT/US2015/053273

§ 371 Date: Mar. 29, 2018

(51) Int. Cl. H04L 29/08; H04L 12/24; H04L 12/911; H04L 29/06

(52) U.S. Cl. CPC H04L 67/18; H04L 41/0896; H04L 67/141; H04L 47/70; H04L 65/60; H04L 67/16

(57) ABSTRACT

Ways to provide multimedia content based on location and associated venue are described. A user device is able to discover and utilize a communication link associated with the venue, a display associated with the venue or a gateway associated with the venue. The display is able to provide multimedia content via the communication link. A server is able to determine a location of the user device, associated the user device with the venue, and configure content items to be delivered to the display. Such configuration includes customization of graphics or interfaces, access to promotions and/or discounts, access to restrict content and/or download capabilities, and/or monetization of content provision. In addition, the gateway (and/or other elements) may allocate bandwidth to multiple user devices, based on the configuration information.

### BACKGROUND

Many consumers carry mobile devices such as smartphones and tablets. In addition, such users may have access to various display devices within a range of venues, such as hotels, airplanes, restaurants, etc.

These consumers may wish to access various third-party content providers, such as streaming audio and/or video content providers such as M-Go, Netflix, Amazon, and the like. Such access may require a network connection that would typically be available through the venue.

These venues may wish to customize the user experience to match the venue. In addition, the venues may wish to promote or otherwise provide access to particular content providers, as appropriate.

Thus, there exists a need for ways to optimize and deliver content to users based at least partly on venue association.

### SUMMARY

Ways to provide multimedia content based on location and associated venue are described. A user device is able to discover and utilize a communication link associated with the venue, a display associated with the venue, or a gateway associated with the venue. The display is able to provide multimedia content via the communication link. A server is able to determine a location of the user device, associated the user device with the venue, and configure content items to be delivered to the display. Such configuration includes customization of graphics or interfaces, access to promotions and/or discounts, access to restrict content and/or download capabilities, and/or monetization of content provision. In addition, the gateway (and/or other elements) may allocate bandwidth to multiple user devices, based on the configuration information.

Some embodiments may provide a system that allows various venues (e.g., hotels, restaurants, airplanes, trains, buses, etc.) to customize and/or optimize content delivery to associated users. Such users may be associated with the venue based on various appropriate criteria (e.g., location, network connectivity, etc.).

In some embodiments, a user device may be able to communicate with a display device and/or gateway provided by a venue. The venue may be associated with a communication link such as a networked Internet connection.

The user device may be able to use such a communication link to access various content items such as streaming services, video on demand services, etc. Such content items may be associated with various content providers.

In some embodiments, each venue may be associated with one or more content providers. Such associations may allow for provision of additional content, access to special offers and/or discounts, prioritized allocation of bandwidth, provision of customized graphics, interfaces, and/or content, and/or other customization of attributes associated with content provision.

Some embodiments may allow access to additional content and/or provide rewards or discounts based on user status (e.g., membership level with a hotel rewards program, number of flight miles accumulated, etc.).

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of an exemplary system of some embodiments;

FIG. 2 illustrates a flow chart of an exemplary client-side process used by some embodiments to deliver content;

FIG. 3 illustrates a flow chart of an exemplary server-side process used by some embodiments to deliver content;

FIG. 4 illustrates a flow chart of an exemplary process used by some embodiments to customize content delivery; and

FIG. 5 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to optimize and monetize content provision via a venue which can be a hotel, restaurant, airplane, park, retailer, shopping mall, coffee shop, and the like. Such venues may offer improved service, expanded content selection, increased bandwidth, and/or other relevant benefits to users that access content via a communication link provided by the venue.

A first exemplary embodiment provides a method that provides multimedia content via a communication link associated with a venue. The method includes discovering, at a user device, available communication links, discovering, at the user device, available display devices; retrieving, at the user device, location information, receiving, from the server, content configuration information, and allocating bandwidth on the communication link based on said configuration information.

A second exemplary embodiment provides a user device that provides multimedia content via a communication link associated with a venue. The user device includes a processor for executing a set of instructions, and a non-transitory medium that stores the set of instructions. The set of instructions includes discovering, at a user device, available communication links, discovering, at the user device, available display devices, retrieving location information; receiving, from the server, content configuration information; and allocating bandwidth on the communication link based on said configuration information.

A third exemplary embodiment provides a method that provides multimedia content via a communication link associated with a venue. The method includes identifying, at a server, a user device, identifying, at the server, a display device, determining, at the server, a location of the user device, identifying, at the server, a venue; identifying, at the server, a content provider, defining and sending configuration information to at least one of the user device and the display device, the configuration information based at least partly on at least one of an identity of the venue and an identity of the content provider, and sending, to a local gateway associated with the venue, a bandwidth allocation, the bandwidth allocation based at least partly on the configuration information.

A fourth exemplary embodiment provides a server that provides multimedia content via a communication link associated with a venue. The server includes a processor for executing a set of instructions, and a non-transitory medium that stores the set of instructions. The set of instructions includes identifying, at a server, a user device, identifying, at the server, a display device, determining, at the server, a location of the user device, identifying, at the server, a venue, identifying, at the server, a content provider, defining and sending configuration information to at least one of the user device and the display device, the configuration information based at least partly on at least one of an identity of the venue and an identity of the content provider, and sending, to a local gateway associated with the venue, a bandwidth allocation, the bandwidth allocation based at least partly on the configuration information.

Several more detailed embodiments are described in the sections below. Section I provides a description of a hardware architecture used by some embodiments. Section II then describes various methods of operation used by some embodiments. Lastly, Section III describes a computer system which implements some of the embodiments.

### I. System Architecture

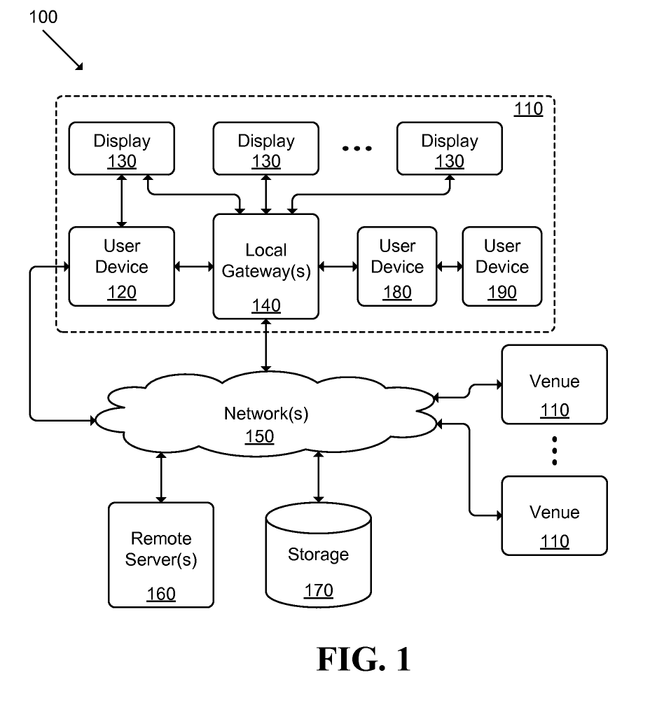

FIG. 1 illustrates a schematic block diagram of an exemplary system 100 of some embodiments. As shown, the system may include a set of venues 110, where each venue may include a set of user devices 120, a set of displays 130, and a local gateway 140. The system 100 may further include a set of networks 150, a set of remote servers 160, and one or more storages 170.

Each venue 110 may be an establishment (such as a hotel, restaurant, etc.), a vehicle (such as a bus, train, airplane, etc.), and/or other appropriate set of associated elements. One or more venues may be grouped together and/or otherwise associated (e.g., planes associated with an airline, locations associated with a single hotel chain, etc.). The venue need not be defined by physical boundaries, and may include any devices that are able to access one or more networks via gateway 140.

Each user device 120 may be a device capable of communicating with other elements, processing data, and/or executing instructions. Such a device may be, for instance, a smartphone, tablet, wearable device, computer, laptop, portable game system, etc. Such devices may utilize various appropriate resources (e.g., one or more dedicated applications, a web browser, etc.). The user device may be a dedicated media device, for example, a universal serial bus (USB) keychain, portable streaming device, etc.

Each display 130 may be a device capable of providing multimedia content to one or more users. The display may be, for instance, a television, monitor, handheld device, etc. In some cases, a user device 180 may be used as a display (e.g., a user may consume content on a laptop, tablet, or smartphone, etc.) where the user device receives content via the gateway 140. As another example, user device 180 and user device 190 may be used to consume content, where user device 180 (e.g., a smartphone) may retrieve the content via the gateway 140 and provide the content to the display user device 190 (e.g., a tablet).

The local gateway 140 may provide network connectivity to the other venue devices, distribute content to the devices, and/or otherwise interact with multiple devices associated with the venue 110. In some embodiments, the local gateway 140 may include a server or other such computing device. The local gateway may communicate with the other devices in various appropriate ways (e.g., using wireless or wired network paths). In some embodiments, the user devices 120 and/or displays 130 may be able to connect directly to one or more networks 150 without need of a local gateway 140. The gateway may include multiple distributed devices such as servers, wireless transmitters and receivers, etc.

The networks 150 may include various wired networks (e.g., Ethernet), wireless networks (e.g., WiFi networks, cellular networks, etc.), Internet connected networks, and/or other multi-device communication pathways (e.g., Bluetooth link, tether, etc.).

The remote server 160 may be able to communicate across network 150 to the various devices 120-140 associated with each venue 110. The remote server 160 may provide content, data, etc. to the other elements. In some embodiments, the remote server may be associated with and/or be able to access a resource such as a content provider.

Each storage 170 may be a storage device capable of receiving, retaining, and/or delivering data and/or instructions. The storage may be accessible through the network 150 and/or storages 170 may be locally accessible to various resources (e.g., a server may have direct connection to a storage). Storage 170 may be a hard drive, an optical storage medium, an electo-magnetic storage medium, a compact disc, a digital versatile disc, a Blu-Ray disc, Random Access Memory, holographic storage, server based storage, etc.

During operation, a user device 120 may be associated with a display 130. Such association may include physical connection, wireless pairing, a pairing enabled by a user, and/or other appropriate actions. Next, the user device 120 may be activated (e.g., by connection to the display, by executing an application associated with a media service, by accessing a website associated with a media service, etc.). The user device 120 may then perform discovery of displays 130, gateways 140, networks 150, and/or other appropriate elements. In addition, the user device 120 may determine a location of the device (e.g., using global positioning system components, by sending a query to the network, by determining a location associated with a hot spot or other access point, etc.). Discovery and/or location determination may be at least partly performed by one or more external resources such as local gateway 140, server 160, etc.

The gateway 140 (and/or other appropriate elements) may determine whether the venue 110 providing local network connectivity has a relationship with the media service. For instance, a hotel chain may have a relationship with a video on demand service such as M-GO that is provided using a local area network. As another example, a coffee shop may provide wireless connectivity and also have a relationship with a streaming content provider. If there is no such relationship, the content may be provided using the available resources such as the gateway 140, displays 130, user devices 120, etc. If there is a relationship, various content attributes may be selected and/or modified based on the relationship.

Such attributes may include, for example, graphics or user interfaces associated with the venue 110, promotions and/or discounts related to content items available via the venue resources, access to venue-specific content, access to additional restricted-access content items, etc. In addition, some embodiments may allocate bandwidth at least partly based on a relationship between the venue and a content provider. Some embodiments may provide the ability to download content to a user device 120 while the device is associated with the venue 110 (e.g., during a stay in a hotel). Some embodiments may allow the venue to monetize the provision of content over a local network by tabulating user expenditures on content that is provided via the local network (i.e., a venue may receive a percentage of sales made using the local network and/or other resources provided by the venue).

One of ordinary skill in the art will recognize that system 100 may be implemented in various different ways without departing from the scope of the disclosure. For instance, different embodiments may include additional elements and/or eliminate some elements. As another example, different embodiments may include different communication pathways than shown. In addition, different embodiments may include different numbers of individual devices and/or associate such devices in various appropriate ways.

### II. Methods of Operation

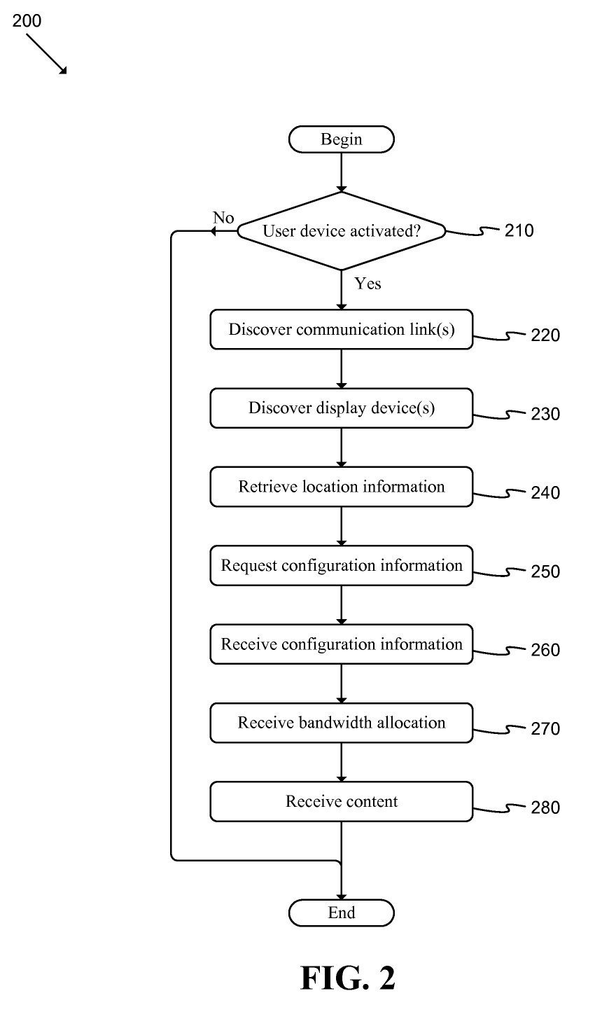

FIG. 2 illustrates a flow chart of an exemplary client-side process 200 used by some embodiments to deliver content. Such a process may be executed by a device such as user device 120. In some embodiments, the process may be performed at least partly using additional devices, such as display 130, gateway 140, and/or server 160. The process may begin, for instance, when a user launches an application associated with a content provider, accesses a website associated with provision of content, connects to a venue resource, etc. The client-side process 200 may be used in combination with a complementary server-side process. Such a server-side process may be executed by a device such as gateway 140 and/or server 160.

As shown, the process may determine (at 210) whether a user device has been activated. Such a determination may be made based on various relevant criteria, such as whether a user device has been communicatively coupled to a display. The activation may be performed automatically (e.g., based on device pairing), based on received user input, and/or other appropriate ways.

In some cases, activation may require satisfaction of multiple criteria. For instance, in some embodiments, an activated device must be associated with a display and a network connection or an activated device must be associated with a network connection and a content provider. If the process determines (at 210) that no user device has been activated, the process may end. In such a case, the process may initiate provision of default content or otherwise provide access.

If the process determines (at 210) that a user device has been activated, the process may then discover (at 220) any available communication links. Such links may include, for instance, wireless networks, Bluetooth links, cellular links, and/or wired connections. Depending on the particular venue, links may be established with multiple elements. For instance, a user device may link to a remote server and a gateway.

The process may then discover (at 230) display devices. Such display devices may be accessed by a communication link discovered at 220. In some embodiments, the display device may be connected to a user device (e.g., using a USB or high definition multimedia interface (HDMI) connection) that is able to communicate with other user devices (e.g., a smartphone, tablet, etc.). In some embodiments, the user device may be associated with at least one display. For instance, the user device may establish a communication link with the display (e.g., via a wired or wireless link). As another example, the user device (and/or display) may communicate with a gateway or remote server that is able to identify the display that is to be associated with a user device. The gateway or remote server may then provide content to the associated display, where the content may be provided based on communications received from the user device and/or the display.

Next, the process may determine or retrieve (at 240) location information. Such information may be retrieved by the user device, for instance using a positioning system such as a global positioning system (GPS). Alternatively, the location may be determined using information associated with other elements such as the display, the gateway, etc. The location may be determined based on local network identity, media access control (MAC) address information associated with other devices connected to the local network, authentication information provided by the gateway or other communication link (e.g., when using a hotspot), etc. Some embodiments may further determine whether the location (and/or associated venue) is associated with any media service.

Process 200 may then request (at 250) and receive (at 260) configuration information. Alternatively, the information may be provided regardless of whether a request is made. For instance, the gateway or server may determine that a user device is trying to access a media provider using a communication link provided by a particular venue and automatically send appropriate configuration information. The configuration information may include, for instance, content attributes described above, user interface elements, etc.

The process may then receive (at 270) bandwidth allocation information. Such information may be applied in various appropriate ways. In some cases, the bandwidth allocation may be received at a local gateway and used to provision bandwidth among user devices, displays, etc. Bandwidth may be allocated based on various relevant factors. For instance, a hotel chain may have a relationship with a streaming provider and allocate bandwidth to that provider in a preferential manner. As another example, a user device may be associated with a user account with a venue (e.g., a frequent flyer program associated with an airline, a hotel rewards program, etc.) where devices associated with such user accounts are provided preferential allocation. Such preferential allocation may include allocation of greater bandwidth to such preferred resources and/or reservation of some portion of available bandwidth for such sources.

Next, the process may receive (at 280) content and then may end. Such content may be provided using various appropriate user interfaces, such as playback elements, selection lists, etc. The received content may include content selected by a user, default content associated with a venue, and/or other appropriate content.

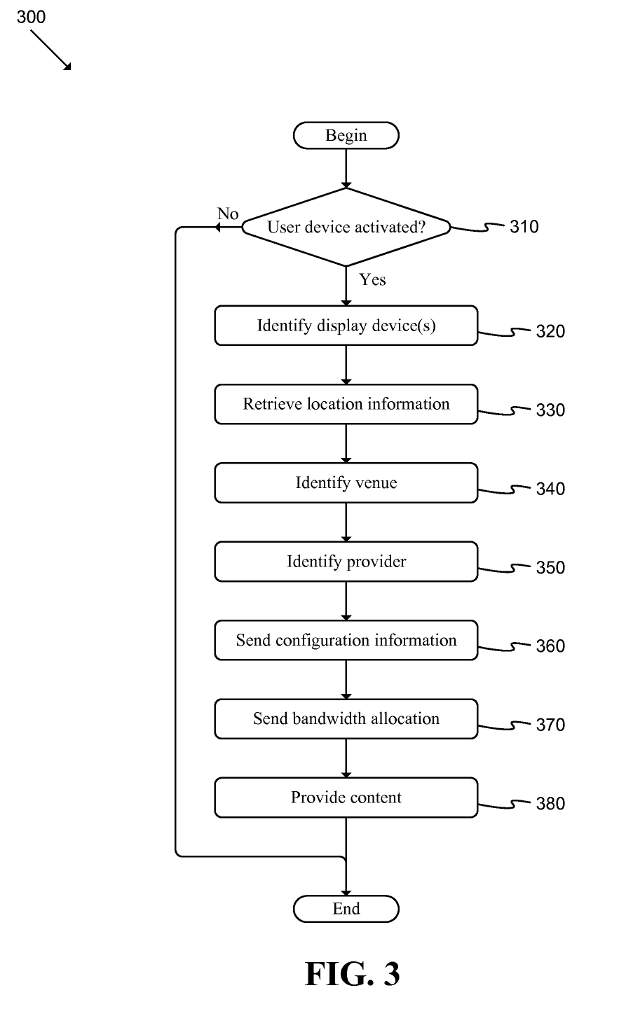

FIG. 3 illustrates a flow chart of an exemplary server-side process 300 used by some embodiments to deliver content. Such a process may be executed by a device such as local gateway 140 and/or server 150. In some embodiments, the process may be performed at least partly using additional devices, such as display 130 and/or user device 120. The process may begin, for instance, when a user launches an application associated with a content provider, accesses a website associated with provision of content, connects to a venue resource, etc. The server-side process 300 may be used in combination with a complementary client-side process, such as process 200.

Process 300 may determine (at 310) whether a user device has been activated. Such a determination may be made based on various relevant criteria, such as whether a user device has been communicatively coupled to a display or gateway. In some cases, activation may require satisfaction of multiple criteria. For instance, in some embodiments, an activated device must be associated with a display and a network connection or an activated device must be associated with a network connection and a content provider. The process may also identify the activated user device (e.g., by retrieving identifying information from the user device) and/or form a communication link between the server and the user device. Such a link may utilize other elements, such as a display, gateway, etc.

If the process determines (at 310) that no user device has been activated, the process may end. In such a case, the process may initiate provision of default content or otherwise provide access.

If the process determines (at 310) that a user device has been activated, the process may then identify (at 320) any linked display devices. Such identification may be based on information received from a user device, display, gateway, and/or other appropriate element.

Next, the process may determine or retrieve (at 330) location information. Such information may be retrieved from a user device and/or other appropriate resource. The location may be determined using information associated with elements such as the display, the gateway, etc. The location may be determined based on local network identity, MAC address information associated with other devices connected to the local network, authentication information provided by the gateway or other communication link (e.g., when using a hotspot), etc.

The process may then identify (at 340) a venue. The venue may be identified based on various relevant criteria (e.g., location of the user device, identity of a gateway, network identification, etc.). Some embodiments may further determine whether the venue is associated with any media service.

The process may then identify (at 350) a content provider, if applicable. The content provider may be identified based on information obtained from a user device application, a request for a particular web site, etc. Alternatively, a content provider such as a video on demand service may be identified based on the venue identity.

Next, the process may define and send (at 360) configuration information to the client-side process. Such configuration information may include, for instance, content attributes described above, user interface elements, etc. In some embodiments, the configuration information may be sent in response to a request from the client-side application.

The process may then send (at 370) bandwidth allocation information. Such allocation may be determined in various appropriate ways. In some cases, the bandwidth allocation may be sent to a local gateway in order to provision bandwidth among user devices, displays, etc.

Bandwidth may be allocated based on various relevant factors. For instance, a hotel chain may have a relationship with a streaming provider and allocate bandwidth to that provider in a preferential manner. As another example, a user device may be associated with a user account with a venue (e.g., a frequent flyer program associated with an airline, a hotel rewards program, etc.) where devices associated with such user accounts are provided preferential allocation. As another example, a venue may provide some content items (e.g., new releases on a video on demand service) that are associated with preferential bandwidth allocations.

Such preferential allocation of bandwidth may include allocation of greater bandwidth to such preferred resources and/or reservation of some portion of available bandwidth for such sources. The bandwidth allocation may be provided as a percentage, ratio, or other appropriate scalable value such that a local gateway (and/or other appropriate resource) may be able to allocate bandwidth according to various relevant factors (e.g., total available bandwidth, current number of users, amount of reserved bandwidth, etc.).

Process 300 may then provide (at 380) content and then end. Such content may be provided based on various appropriate criteria (e.g., user selections, venue identity, etc.).

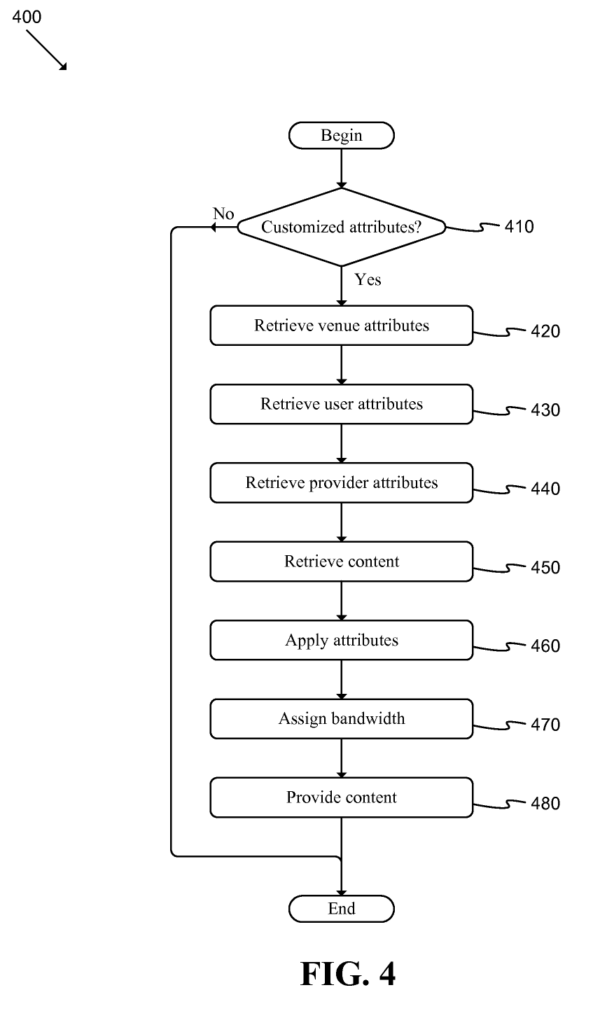

FIG. 4 illustrates a flow chart of an exemplary process 400 used by some embodiments to customize content delivery. Such a process may be executed by a device such as server 150. In some embodiments, the process may be performed at least partly using additional devices, such as display 130, gateway 140 and/or user device 120. The process may begin, for instance, when customized content is provided via a process such as process 200 and/or process 300. The server-side process 400 may be used in combination with a complementary client-side process, such as process 200 and/or may be performed as part of process 300 (e.g., operation 380).

As shown, process 400 may determine (at 410) whether there are customized attributes associated with the access session. Such a determination may be made based on various relevant criteria (e.g., user identity, content provider, venue, device type, etc.). If the process determines that there are no customized attributes available, the process may end.

If the process determines (at 410) that there are customized attributes, the process may then retrieve (at 420) venue attributes. Such venue attributes may include, for instance, a list of associated providers, identification and/or location information regarding the venue, display types, connection types, etc.

Next, the process may retrieve (at 430) user attributes. Such user attributes may include, for instance, a user identity and/or profile information, user preferences, device type, and/or other appropriate attributes.

The process may then retrieve (at 440) provider attributes. Such attributes may include, for instance, provider identity, content type(s), associated venues, and/or other appropriate attributes.

Next, the process may retrieve (at 450) content. Such content may be retrieved based on user selection, system defaults, venue preferences, provider preferences, and/or other relevant criteria.

Process 400 may then apply (at 460) the retrieved attributes. Such application may include, for instance, generation of venue-specific interfaces or content access lists, promotions and/or discounts, optimization based on display device type or capabilities, and/or otherwise apply the retrieved attributes.

The process may then assign (at 470) or allocate available bandwidth. For instance, an associated content provider may have a reserved portion of available bandwidth while other providers may be relegated to the remaining bandwidth. Assignment of bandwidth may include configuration of various devices (e.g., local gateways, servers, wireless access points, cellular network elements, etc.).

Next, the process may provide (at 480) content and then may end. Such content may be provided based on various appropriate criteria (e.g., user selections, venue identity, etc.).

One of ordinary skill in the art will recognize that processes 200, 300, and 400 may be implemented in various different ways without departing from the scope of the disclosure. For instance, different embodiments may include additional operations and/or omit some operations. As another example, the operations may be performed in a different order than shown. Each process may be divided into multiple sub-processes and/or performed as part of a macro process. Each process, or portions thereof, may be performed iteratively, or based on some criteria.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

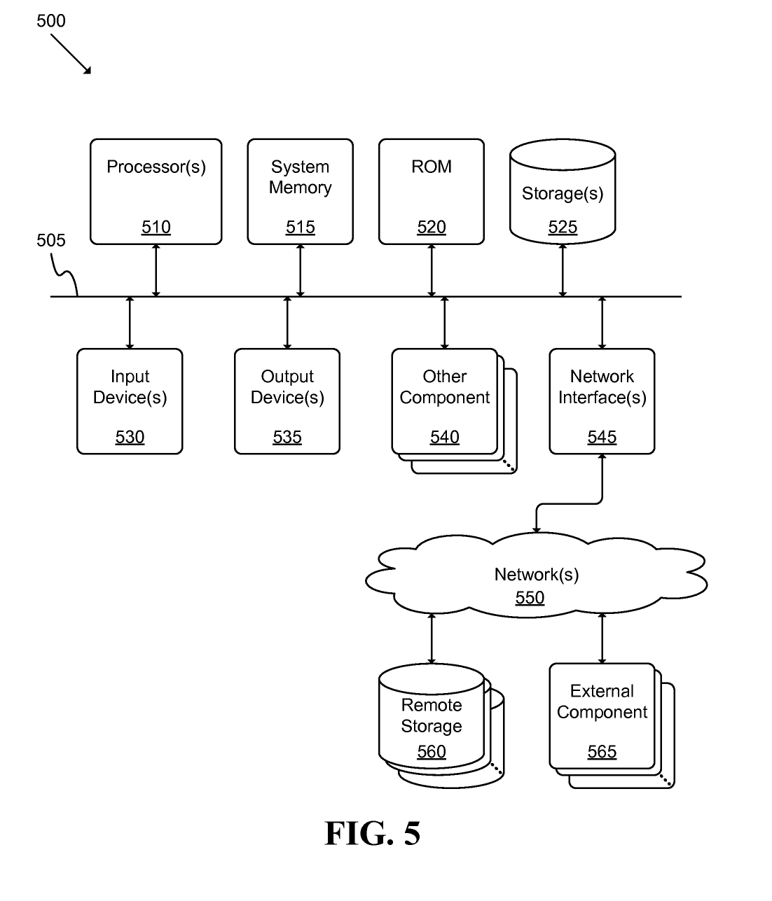

FIG. 5 illustrates a schematic block diagram of an exemplary computer system 500 used to implement some embodiments. For example, the system described above in reference to FIG. 1 may be at least partially implemented using computer system 500. As another example, the processes described in reference to FIGS. 2-4 may be at least partially implemented using sets of instructions that are executed using computer system 500.

Computer system 500 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 500 may include at least one communication bus 505, one or more processors 510, a system memory 515, a read-only memory (ROM) 520, permanent storage devices 525, input devices 530, output devices 535, various other components 540 (e.g., a graphics processing unit), and one or more network interfaces 545.

Bus 505 represents all communication pathways among the elements of computer system 500. Such pathways may include wired, wireless, optical, and/or other appropriate communication pathways. For example, input devices 530 and/or output devices 535 may be coupled to the system 500 using a wireless connection protocol or system.

The processor 510 may, in order to execute the processes of some embodiments, retrieve instructions to execute and/or data to process from components such as system memory 515, ROM 520, and permanent storage device 525. Such instructions and data may be passed over bus 505.

System memory 515 may be a volatile read-and-write memory, such as a random access memory (RAM). The system memory may store some of the instructions and data that the processor uses at runtime. The sets of instructions and/or data used to implement some embodiments may be stored in the system memory 515, the permanent storage device 525, and/or the read-only memory 520. ROM 520 may store static data and instructions that may be used by processor 510 and/or other elements of the computer system.

Permanent storage device 525 may be a read-and-write memory device. The permanent storage device may be a non-volatile memory unit that stores instructions and data even when computer system 500 is off or unpowered. Computer system 500 may use a removable storage device and/or a remote storage device as the permanent storage device.

Input devices 530 may enable a user to communicate information to the computer system and/or manipulate various operations of the system. The input devices may include keyboards, cursor control devices, audio input devices and/or video input devices. Output devices 535 may include printers, displays, and/or audio devices. Some or all of the input and/or output devices may be wirelessly or optically connected to the computer system.

Other components 540 may perform various other functions. These functions may include performing specific functions (e.g., graphics processing, sound processing, etc.), providing storage, interfacing with external systems or components, etc.

Finally, as shown in FIG. 5, computer system 500 may be coupled to one or more networks 550 through one or more network interfaces 545. For example, computer system 500 may be coupled to a web server on the Internet such that a web browser executing on computer system 500 may interact with the web server as a user interacts with an interface that operates in the web browser. Computer system 500 may be able to access one or more remote storages 560 and one or more external components 565 through the network interface 545 and network 550. The network interface(s) 545 may include one or more application programming interfaces (APIs) that may allow the computer system 500 to access remote systems and/or storages and also may allow remote systems and/or storages to access computer system 500 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that provides multimedia content via a communication link associated with a venue, the method comprising:
discovering, at a user device, available communication links;
discovering, at the user device, available display devices;
retrieving, at the user device, location information;
receiving, from the server, content configuration information; and
allocating bandwidth on the communication link based on said configuration information.

2. The method of claim 1, wherein the content configuration information comprises a set of customized attributes associated with the venue, the set of customized attributes comprising at least one of: graphics, user interface elements, restricted-access content items, and download permission.

3. The method of claim 1, wherein each communication link comprises at least one of an Ethernet, a Bluetooth link, a wireless local area network, a cellular network, and a distributed network.

4. The method of claim 1 further comprising:
associating the user device with a particular display from among the available display devices; and
receiving at least one content item at the particular display.

5. The method of claim 1, wherein the location information is retrieved from the server.

6. A user device that provides multimedia content via a communication link associated with a venue, the user device comprising:
a processor for executing a set of instructions; and
a non-transitory medium that stores the set of instructions, wherein the set of instructions comprises:
discovering, available communication links;
discovering, available display devices;
retrieving, location information;
receiving content configuration information; and
allocating bandwidth on the communication link based on said configuration information.

7. The user device of claim 6, wherein the content configuration information comprises a set of customized attributes associated with the venue, the set of customized attributes comprising at least one of: graphics, user interface elements, restricted-access content items, download permission, and bandwidth allocation.

8. The user device of claim 6, wherein each communication link comprises at least one of an Ethernet, a Bluetooth link, a wireless local area network, a cellular network, and a distributed network.

9. The user device of claim 6, wherein the set of instructions further comprises:
associating the user device with a particular display from among the available display devices; and
receiving at least one content item at the particular display.

10. The user device of claim 6, wherein the location information is retrieved from the server.

11. A method that provides multimedia content via a communication link associated with a venue, the method comprising:
identifying, at a server, a user device;
identifying, at the server, a display device;
determining, at the server, a location of the user device;
identifying, at the server, a venue;
identifying, at the server, a content provider;
defining and sending configuration information to at least one of the user device and the display device, the configuration information based at least partly on at least one of an identity of the venue and an identity of the content provider; and
sending, to a local gateway associated with the venue, a bandwidth allocation, the bandwidth allocation based at least partly on the configuration information.

12. The method of claim 11, wherein the venue is identified based at least partly on at least one of the location of the user device and an identity of the display device.

13. The method of claim 11, wherein the location of the user device is determined based at least partly on at least one of: venue network identity, media access control information associated with other devices associated with the venue, and authentication information provided by the venue network.

14. The method of claim 11 further comprising establishing a communication link between the server and the user device.

15. The method of claim 11 further comprising sending at least one content item to the display device.

16. A server that provides multimedia content via a communication link associated with a venue, the server comprising:
a processor for executing a set of instructions; and
a non-transitory medium that stores the set of instructions, wherein the set of instructions comprises:
identifying, a user device;
identifying, a display device;
determining, a location of the user device;
identifying, a venue;
identifying, a content provider;
defining and sending configuration information to at least one of the user device and the display device, the configuration information based at least partly on at least one of an identity of the venue and an identity of the content provider; and
sending, to a local gateway associated with the venue, a bandwidth allocation, the bandwidth allocation based at least partly on the configuration information.

17. The server of claim 16, wherein the venue is identified based at least partly on at least one of the location of the user device and an identity of the display device.

18. The server of claim 16, wherein the location of the user device is determined based at least partly on at least one of: venue network identity, media access control information associated with other devices associated with the venue, and authentication information provided by the venue network.

19. The server of claim 16, wherein the set of instructions further comprises establishing a communication link between the server and the user device.

20. The server of claim 16, wherein the set of instructions further comprises sending at least one content item to the display device.
